(19) United States
(12) Patent Application Publication
(10) Pub. No.: US 2026/0262644 A1
(43) Pub. Date: Sep. 10, 2026

(54) Antifungal compositions comprising natamycin

(71) Applicant: Patent Nata B.V., Wageningen (NL)

(72) Inventors: Emilie Flavie FRADIN, Renkum (NL); Wilhelmus Maria VAN DER KRIEKEN, Wageningen (NL)

(21) Appl. No.: 19/162,589

(22) PCT Filed: Mar. 6, 2024
(86) PCT No.: PCT/NL2024/050105

§ 371 Date: Sep. 5, 2025

(30) Foreign Application Priority Data
Mar. 6, 2023 (EP) 23160277.2

(51) Int. Cl. A01N 43/90; A01N 25/02; A01P 3/00

(52) U.S. Cl. CPC A01N 43/90; A01N 25/02; A01P 3/00

(57) ABSTRACT

The invention relates to a composition comprising natamycin and a water-immiscible solvent. The invention further relates to methods employing said composition for protecting a food product, a plant or plant part, for improving the development and/or yield of an agricultural plant, and for protecting a soil and/or a growth substrate.

### FIELD

The invention relates to compositions to control fungal diseases on food products, plants and plant parts and to improve development and yield of plants.

### INTRODUCTION

Plants can be attacked by many different phytopathogenic fungi which cause tremendous losses in crops worldwide. Fungal growth may also result in loss of nutrients, formation of off flavors and destruction of tissue causing quality loss after processing. In many cases, fungal infections occur in the field after which the fungi develop during storage if the conditions are favorable resulting in post-harvest losses of e.g. grain, seed, flower bulbs, seed-potatoes, fruit and vegetables or moulding of processed foods such as breakfast cereals, juices or fruit cuts.

Phytopathogenic fungi in the soil, in the field (on agricultural plant parts such as seeds, bulbs and plants) and after harvesting (e.g. on cereals, vegetables and fruits) are generally controlled by fungicides, especially synthetic fungicides. However, many fungicides lose their activity over the years due to their repeated use which resulted in development of fungal resistance. For example, the occurrence of a single point mutation in fungi may affect the performance of strobilurin fungicides. Development of resistance often results from repeated treatments and the application of higher amounts and/or of more than one fungicide.

For many decades the polyene macrolide antifungal natamycin has been used to prevent fungal growth on food products, mainly cheeses and dry fermented sausages. Natamycin was first described in 1957 and is produced by fermentation using a Streptomyces species such as Streptomyces natalensis. Nowadays this natural antimicrobial is widely used throughout the world as a food additive.

Polyene fungicides such as natamycin have been reported to interact with the plasma membrane, especially with sterols. Natamycin has been reported to interact with ergosterol, the main sterol in membranes in the fungal classes ascomycetes and basidiomycetes and in yeasts and amoeba (the Welscher et al., 2008. J Biol Chem 283:6393-6401). By this interaction the membrane fluidity and the function of membrane-bound enzymes is modulated (Douglas and Konopka, 2014. Annu Rev Microbiol 68:377-393). Ergosterol is absent in other organisms such as bacteria, oomycetes, animals, and humans. Natamycin is considered safe for humans and is used against fungicidal activities in cheese and sausages.

Natamycin has a long history of safe use and, more important, up to now resistant fungi have never been found in nature. Over the years quite some literature has been published describing a potential use of natamycin in many agricultural applications. However, it has been reported that natamycin is ineffective against oomycetes such as Phytophthora infestans and Plasmopara viticola. In fact, natamycin is included in selection media for the isolation of Phytophthora species, in order to prevent growth of true fungi (Eckert and Tsao, 1960. Plant Disease Reporter 44:660-661). Reports that natamycin could be used to protect a product against oomycetes, e.g. WO2012/162412, WO2014/085576, WO2014/191449, WO2019/011630, WO2017043972, are without supporting data that natamycin is able to combat oomycetes. A reason for this ineffectiveness could be that oomycetes lack ergosterol in their membranes (WHO Technical Report Series 909, 2002. Evaluation of certain food additives and contaminants).

To combat oomycetes, agrochemicals such as phenylamides (PAs), quinone outside inhibitors (QoIs), carboxylic acid amides (CAAs), multisite inhibitors, and combinations thereof are most widely used. However, resistance has evolved against most of these inhibitors in many pathogenic oomycete species.

There is thus a need for natural solutions for combatting oomycetes and reducing economic losses in agriculture, that not likely will induce resistance. Surprisingly, it was found that compositions that improve the efficacy of natamycin against oomycetes, also increase efficacy of natamycin against moulds and can be used to protect food products, plants, plant parts, soil and/or growth substrate from infection by fungus and fungus-like organisms, including true fungi.

### BRIEF DESCRIPTION OF THE INVENTION

The invention provides a composition comprising natamycin and a water-immiscible solvent (Wis) in a ratio of between 1:20 and 20:1 (w/w; natamycin:Wis), preferably between 1:5 and 5:1 (w/w), and one or more surfactants.

It was found that natamycin, in combination with a water-immiscible solvent (Wis), acts synergistically against different classes of fungi and fungi-like organisms, including ascomycetes, basidiomycetes and oomycetes. Especially the high efficacy of this combination against oomycetes is very remarkable since natamycin itself hardly has an effect on these fungi-like organisms.

Said Wis may be an ester such as a lactate ester, a ketone, an amide, a polyethylene- or polypropylene-oxide, an aliphatic and/or aromatic hydrocarbon, an ether, a triglyceride, or a mixture thereof. Said Wis preferably comprises one or more linear or branched lactate esters.

A composition of the invention may further comprise one or more of a terpene, a terpenoid, or a mixture thereof.

The addition of a terpenes and/or terpenoid to a composition of the invention was found to synergistically enhance the effect of a composition comprising natamycin and a Wis against all fungi and fungus-like organisms tested.

Natamycin is known to act via ergosterol in the membranes of true fungi (ascomycetes and basidiomycetes). The Wis may induce an extra, as yet unknown, mode of action for natamycin that differs from it's binding to ergosterol. Since Wis are known as (mild) degreasing compounds, it may be hypothesized that natamycin acts on Wis-interfered cell membranes of fungi and fungus-like organisms. Terpenes and terpenoids, which also act on cell membranes, may further enhance this Wis-effect and further stimulate the activity of natamycin.

A composition of the invention preferably comprises natamycin:Wis:terpene/terpenoid in a ratio between 1:5:5 and 5:1:0.2 (w/w).

A composition of the invention preferably is an oil dispersion (OD), an emulsifiable concentrate (EC), or a suspo-emulsion (SE).

The invention further provides a method for protecting an agricultural plant or plant part, comprising providing a composition according to the invention, and applying said composition to said agricultural plant or plant part. Said plant part preferably is a leaf, seed, bulb, fruit or vegetable, preferably seed. A method of the invention provides protection against ascomycetes, basidiomycetes and oomycetes.

The invention further provides a method for improving the development and/or yield of an agricultural seed or plant, comprising a composition according to the invention, and contacting the seed or plant with said composition.

The invention further provides a method for protecting a soil and/or a growth substrate, the method comprising applying to said soil and/or a growth substrate a composition according to the invention. Said growth substrate preferably is a mushroom growth substrate.

A composition of the invention may be undiluted or diluted in an aqueous solution or in oil, prior to providing the composition to a plant, plant part, soil and/or growth substrate in methods of the invention.

The invention further provides a use of a composition according to the invention, for protecting a food product, plant, plant part, soil and/or growth substrate against fungi and fungi-like organisms. Said fungi-like organisms include oomycetes.

### DETAILED DESCRIPTION OF THE INVENTION

### Definitions

The term “water-immiscible solvent (Wis)”, as used herein, refers to a solvent that is not completely miscible with water at all ratio's tested. Said Wis has a solubility in water below 5%, below 4%, below 3%, below 1%, below 0.5%, preferably below 0.25% (v/v). Said Wis can be, or is, a mild degreasing agent. Said Wis preferably includes an ester such as a lactate ester, a ketone, an amide, a polyethylene- or polypropylene-oxide, an aliphatic and/or aromatic hydrocarbon, an ether, a triglyceride, or a mixture thereof.

The term “ester” as used herein, refers to a Wis including ethyl 3-ethoxypropionate (UCAR® Ester EEP, Dow Chemical Company), methyl ester, methyl caprylate (for example, Steposol® C-25; Stepan Company), methyl soyate (for example Steposol® SB-W, Stepan Company; Agnique® ME 18 SD-F, BASF), methyl oleate (for example Radia® 7956, Oleon), dimethyl succinate, diethyl succinate, dipropyl succinate, dimethyl adipate, diethyl adipate, dipropyl adipate, dimethyl glutarate, diethyl glutarate, dipropyl glutarate, bis(2-ethylhexyl) adipate, diisopropyl adipate, dimethyl-2-methyl glutarate, dioctyl maleate, glycerin diacetate, glycerin triacetate, or a mixture thereof such as a mixture of aliphatic diesters including a mixture of dimethyl glutarate (59-67%), dimethyl succinate (20-28%) and dimethyl adipate (9-17%) such as RHODIASOLV® RPDE (Solvay).

The term “lactate ester”, as used herein, refers to a Wis comprising one or more linear or branched alkyl lactates such as butyl lactate, for example PURASOLV® BL, n-propyl lactate, isopropyl lactate, cyclohexyl lactate, 2-ethylhexyl lactate (for example PURASOLV® EHL), 2-methylcyclohexyl lactate, heptyl lactate, octyl lactate, n-hexyl lactate, 1-ethylhexyl lactate, 1-methylhepytyl 5 lactate, 1,3-dimethylhexyl lactate, 2-methylheptyl lactate, 2,4-dimethylhexyllactate, 2,2,4-trimethylpentyl lactate, n-octyl lactate, n-nonyl lactate, 1-methyloctyl lactate, 2-methyloctyl lactate, 1-methylnonyl lactate, 2-propylheptyl lactate and n-decyl lactate, 2,2,4-trimethylpentyl lactate, butyl lactate, or a mixture thereof. Especially preferred is a Wis comprising or consisting of butyl lactate and/or 2-ethylhexyl lactate. The lactate esters may be present in the form of D- and/or L-lactates, whereby L-lactates are preferred.

The term “ketone” as used herein, refers to a Wis including, for example, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctanone, 2,4,6-cycloheptatrien-1-one, acetophenone, propiophenone, 1-(4-methylphenyl)-ethanone, 1-(4-ethylphenyl)-ethanone, 2-methyl-1-phenyl-1-propanone, 1-(3-ethylphenyl)-ethanone, 4-phenyl-2-butanone, 1-phenyl-2-propanone, 1-phenyl-2-butanone, 2-phenyl-3-butanone, butyrophenone, valerophenone, or a mixture thereof.

The term “amide” as used herein, refers to a Wis including, for example, N,N-dimethyloctanamide, N,N-dimethyldecenamide (for example, Hallcomid® 1025, Stepan Company), N,N-dimethyldecanamide (for example Rhodiasolv® ADMA 10, Solvay), N,N,N′,N′-tetrabutylsuccindiamide (TBSA), N,N′-diethyl-N,N′-dibutylsuccindiamide (EBSA), N,N-dimethyloctanamide, N,N′-dimethyl-N,N′-dibutylsuccindiamide (MBSA), dialkylamide and lactams such as pyrrolidones and substituted pyrrolidones, for instance N-octyl pyrrolidone (NOP), or a mixture thereof such as a mixture of N,N-dimethyloctanamide and N,N-dimethyldecanamide (for example, Hallcomid® M-8-10, Stepan Company).

The term “a polyethylene- or polypropylene-oxide”, as used herein, refers to a Wis that is an oxide such as diethylene glycol monoethyl ether, ethylene glycol monobutyl ether, diethylene glycol monoethyl ether, diethylene glycol mono-n-butyl ether and monopropylene glycol monobutyl ether.

The term “aliphatic and/or aromatic hydrocarbon”, as is used herein, refers to a Wis that is an aliphatic/cycloaliphatic hydrocarbon such as, for example, mineral oil, isoalkane, hexane, heptane, octane, nonane, decane, cyclopentane, cyclohexane, decalin, isoparaffin hydrocarbon (for example, Isopar™ V and Isopar™ P, Exxon Mobil), paraffinic oil (for example Solvesso™ 200, ExxonMobil), or white oil, or an aromatic hydrocarbon such as, for example, benzene, petroleum, alkylbenzenes and spindle oil, xylene, toluene, alkylnaphthalene, or a dearomatized hydrocarbon such as Exxsol™ D220/240 (ExxonMobil), and mixtures thereof. An example of such mixture is provided by the Solvesso™ series (ExxonMobil) containing blends of hydrocarbons.

The term “ether”, as is used herein, refers to a Wis that is a compound comprising an ether group defined by an oxygen atom connected to two organyl groups, such as, for example, an alkyl-alkyl ether, alkyl-aryl ether, aryl-aryl ether, as well as cyclic ethers such as 1,4-dioxane.

The term “triglyceride”, as used herein, refers to a Wis comprising three fatty acids esterified to glycerol. Examples of such triglyceride include avegetable oil, such as corn oil, sunflower oil, soybean oil, rapeseed oil, and peanut oil.

The term “terpene”, as is used herein, refers to an unsaturated hydrocarbon that is present in plants and animals. A true terpene is made from isoprene (C₅H₈), with a building block of two isoprene molecules (C₁₀H₁₆). Terpenes are usually grouped according to the number of building blocks in the molecule: monoterpenes (C₁₀), sesquiterpenes (C₁₅), diterpenes (C₂₀), triterpenes (C₃₀), tetraterpenes (C₄₀), and polyterpenes such as natural rubber and gutta-percha (C_{1,000-5,000}). Terpene subunits may be connected “head to tail”, “tail to tail”, or even “tail to mid”.

The term “terpenoid”, as is used herein, refers to modified terpenes that contain additional functional groups. Said additional functional groups are usually oxygen-containing.

The term “emulsifiable concentrate”, as used herein, refers to solution or mixture of an active ingredient in a water-immiscible solvent with sufficient surfactant to create an oil/water emulsion when the concentrate is added to water.

The term “oil dispersion”, as used herein, refers to particles of a solid active ingredient that are dispersed in an oil-type solvent.

The term “suspo-emulsion”, as used herein, refers to a suspension of solid particles in water in combination with an oil phase in the form of an emulsion intended for dilution with water prior to use.

The term “surfactant”, as used herein, refers to ionic or non-ionic surface active agents. Examples of surfactants are alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers) or combinations thereof.

The term “increasing biological activity”, as used herein, refers to an improvement of the curative, preventive and/or persistence performance of an active ingredient.

The term “plant part”, as used herein, refers to single cells, cell clumps and plant tissues, including tissue cultures. Examples of plant parts include, but are not limited to, pollen, ovules, leaves, embryos, roots, root tips, anthers, flowers, fruits, shoots, scions, rootstocks, seeds, protoplasts, calli, and the like, preferably leaves, fruits and seeds.

The term “food product”, as is used herein, refers to man-made edible products such as dairy products including cheese and yoghurt, sausages, beverages, and bakery goods such as bread. Said products include processed food- and feed-products including, but are not limited to, dairy products such as hard/semi-hard and soft cheese, shredded cheese, cottage cheese, sour cream, cream cheese, ice cream and dairy desserts such as yoghurt and fruit yoghurt; meat products such as dry fermented sausages, salami, smoked ham and smoked fish; bakery products such as bread, cake, pre-baked bread, toppings and bakery fillings; fruit-derived products such as fruit pulp, marmalade, fruit salads and juices; liquid egg products such as egg yolk, cooled liquid eggs, concentrated frozen and deep frozen eggs; alcoholic and non-alcoholic beverages such as ice-tea, lemonade, bear and wine; animal feed such as broiler feed and pet food; and vegetable-derived products such as ketchup, paste, olive and soya oil, soup, for example tomato soup, and processed starch products such as pasta.

The term “growth substrate”, as is used herein, includes rockwool, compost, earth, humus, casings, peat and mushroom substrate. Mushroom substrates often consists of a blend of natural products like wheat straw bedding containing horse manure, hay, corn cobs, cottonseed hulls, poultry manure, brewer's grain, cottonseed meal, cocoa bean hulls, gypsum etc.

### Compositions of the Invention

The invention relates to a composition comprising natamycin and a water-immiscible solvent (Wis), further comprising one or more surfactants. Said natamycin and Wis are present in said composition in a ratio of between 1:20 and 20:1 (w/w; natamycin:Wis), preferably between 1:10 and 10:1 (w/w), or between 1:5 and 5:1 (w/w), such as 1:4, 1:3, 1:2. 1:1, 2;1, 3:1, or 4:1 (w/w).

Suitable surfactants are surface-active compounds, such as anionic, cationic, nonionic and amphoteric surfactants, block polymers, polyelectrolytes, and mixtures thereof. Such surfactants can have multiple functions, one skilled in the art can decide when to use what surfactant. For example, a surfactant can be used as emulsifier, dispersant/wetting agent, solubilizer, penetration enhancer, protective colloid, anti-foam agents, stabilizer, and a sticking agent. For the present invention, said surfactant is an emulsifier and/or a dispersant/wetting agent.

In a composition of the invention, said emulsifier and/or dispersant/wetting agent as surfactant is preferably selected from an alkylnaphthalene sulfonate such as Morwet® D425 (Nouryon, Amsterdam, The Netherlands), block copolymers such as poly(ethylene oxide)-poly(propylene oxide) block copolymers and poly(ethylene oxide)-poly(butylene oxide) block copolymers, lignin sulphonate, an alkylpolysaccharide such as GLUCOPON® 220 (BASF), dodecylbenzensulfonic acid, an acrylic copolymer such as METASPERSE 500L, a non-ionic block polymer such as a polyalkylene glycol ether, for example ATLAS™ G-5002-L, a 12 poly-hydroxysteric acid-polyethyleneglycol (PEG) block polymer such as ATLOX 4912, a PEG-poly alkyd block polymer such as ATLOX 4914, or a polymeric ester such as ATLOX 4916, a pegylated methyl methacrylate graft copolymer such as, for example, ATLOX 4913, a polysorbate such as TWEEN® 20, TWEEN® 22, TWEEN® 23, TWEEN® 24, TWEEN® 90, di-octylsuccinate, polyoxyethylene/polypropylene, tri-stearyl sulphonate/phosphate, and an ethoxylated tristyrenephenol phosphate such as Soprophor® 3 D33 (Solvay).

A composition of the invention may also comprise two or more surfactants such as an alkylnaphthalene sulfonate and an acrylic copolymer, an alkylpolysaccharide and an ethoxylated tristyrenephenol phosphate, a non-ionic block polymer and a block polymer, or lignin sulphonate and a non-ionic block polymer.

A surfactant or surfactants are preferably present in an amount of between 0.1 up to 50% (w/v), more preferred between 1 to up to 25% (w/v), more preferred between 5 to up to 15% (w/v), such as 6% (w/v), 7% (w/v), 8% (w/v), 9% (w/v), 10% (w/v), 11% (w/v), 12% (w/v), 13% (w/v) and 14% (w/v).

Natamycin, in a composition of the invention, preferably is fractionated, preferably by milling, for example using a bead mill such as Dynomill®. The volume-based average particle size of natamycin preferably is between 0.2 and 10 micrometer, preferably between 0.5 and 5 micrometer, more preferably between 0.5 and 2 micrometer. Methods for determining a volume-based average particle size of a composition according to the invention are known to the skilled person. For example, Hukkanen and Braatz, 2003. Sensors and Actuators B 96:451-459, discuss various methods that can be used for determining the average particle size of a composition, including forward light scattering and ultrasonic extinction. A preferred method is based on laser diffraction analysis, for example using a Analysette 22-MicroTec plus laser-particle-sizer (Fritsch, Idar-Oberstein, Germany).

A composition of the invention may include cellular matter. Said natamycin in a composition according to the invention is preferably produced by fermenting biomass by a fermentation organism. Said natamycin-producing fermentation organism includes, for example, Streptomyces natalensis and S. gilvosporeus. Remnants of the natamycin-producing fermentation organism include compounds present in the fermentation medium such as peptides as a nitrogen source for example yeast extract, and/or non-yeast proteins such as protein hydrolysates, peptones, soy proteins, and beef extract; a metabolizable carbon source (e.g., glucose, molasses, lactose, polysaccharides, corn steep liquor, corn starch, and potato starch); growth factors (e.g., vitamins); inorganic elements (e.g., calcium, potassium, sodium, magnesium, ammonium sulphate); trace elements (e.g., zinc, copper, iron, boron and cobalt); and other breakdown products of the compounds of the fermentation medium. In addition, said cellular may further include other compounds such as nucleic acid molecules such as plasmids, DNA and RNA, ribosomes, intracellular membranes, enzymes, nutrient storage structures, such as glycogen, lipid structures, protein structures and sugar structures. It should be understood that any of the components of the natamycin composition described herein may be combined as if each and every combination were individually listed. For example, in some embodiments, the composition may include natamycin, protein and starch; or natamycin, amino acids, nucleic acid molecules and starch, or natamycin, amino acids, peptidoglycans, nucleic acid molecules and starch.

Methods for producing natamycin by fermenting biomass by a fermentation organism such as S. natalensis and S. gilvosporeus are known in the art. Methods to purify the produced natamycin away from the bulk of the biomass are known in the art. For example, disintegration of the biomass may result in lysis and destruction of all cells of the production organism. The resulting broth comprising natamycin may be filtered to obtain a filtration cake, which subsequently may be treated with an alcohol, preferably methanol and/or ethanol, to disintegrate the biomass and to dissolve at least a portion of the natamycin. If necessary, the pH may be increased to solubilize the natamycin. Subsequent neutralization will result in precipitation of at least a portion of natamycin.

A composition of the invention may be used for soil treatment, to prepare a seed treatment like seed dressing or seed coating, a coating emulsion (e.g. for a food product, fruit, or for plants in the field), a wax that is applied on a food product or fruit (e.g. pineapples, oranges or apples), an oil that is applied by spraying plants in the field (e.g. bananas). A composition of the invention also includes a concentrated dry composition such as e.g. a granulate, a powder and/or a tablet which can be used to prepare compositions for immersions, spraying or dipping agricultural products including food products.

A composition of the invention may further comprise one or more of a terpene, a terpenoid, or a mixture thereof in a ratio (natamycin:Wis:terpene/terpenoid) between 1:5:5 and 5:1:0.2 (w/w), such as 1:4:5, 1:3:5, 1:2:5, 1:1:5, 2:4:5, 2:3:5, 2:2:5, 2:1:5, 3:4:5, 3:3:5, 3:2:5, 3:1:5, 4:4:5, 4:3:5, 4:2:5, 4:1:5, 5:4:5, 5:3:5, 5:2:5, 5:1:5, 1:4:4, 1:3:4, 1:2:4, 1:1:4, 2:4:4, 2:3:4, 2:2:4, 2:1:4, 3:4:4, 3:3:4, 3:2:4, 3:1:4, 4:4:4, 4:3:4, 4:2:4, 4:1:4, 5:4:4, 5:3:4, 5:2:4, 5:1:4, 1:4:3, 1:3:3, 1:2:3, 1:1:3, 2:4:3, 2:3:3, 2:2:3, 2:1:3, 3:4:3, 3:3:3, 3:2:3, 3:1:3, 4:4:3, 4:3:3, 4:2:3, 4:1:3, 5:4:3, 5:3:3, 5:2:3, 5:1:3, 1:4:2, 1:3:2, 1:2:2, 1:1:2, 2:4:2, 2:3:2, 2:2:2, 2:1:2, 3:4:2, 3:3:2, 3:2:2, 3:1:2, 4:4:2, 4:3:2, 4:2:2, 4:1:2, 5:4:2, 5:3:2, 5:2:2, 5:1:2, 1:4:1, 1:3:1, 1:2:1, 1:1:1, 2:4:1, 2:3:1, 2:2:1, 2:1:1, 3:4:1, 3:3:1, 3:2:1, 3:1:1, 4:4:1, 4:3:1, 4:2:1, 4:1:1, 5:4:1, 5:3:1, 5:2:1, 5:1:1, 1:4:0.9, 1:3:0.9, 1:2:0.9, 1:1:0.9, 2:4:0.9, 2:3:0.9, 2:2:0.9, 2:1:0.9, 3:4:0.9, 3:3:0.9, 3:2:0.9, 3:1:0.9, 4:4:0.9, 4:3:0.9, 4:2:0.9, 4:1:0.9, 5:4:0.9, 5:3:0.9, 5:2:0.9, 5:1:0.9, 1:4:0.8, 1:3:0.8, 1:2:0.8, 1:1:0.8, 2:4:0.8, 2:3:0.8, 2:2:0.8, 2:1:0.8, 3:4:0.8, 3:3:0.8, 3:2:0.8, 3:1:0.8, 4:4:0.8, 4:3:0.8, 4:2:0.8, 4:1:0.8, 5:4:0.8, 5:3:0.8, 5:2:0.8, 5:1:0.8, 1:4:0.7, 1:3:0.7, 1:2:0.7, 1:1:0.7, 2:4:0.7, 2:3:0.7, 2:2:0.7, 2:1:0.7, 3:4:0.7, 3:3:0.7, 3:2:0.7, 3:1:0.7, 4:4:0.7, 4:3:0.7, 4:2:0.7, 4:1:0.7, 5:4:0.7, 5:3:0.7, 5:2:0.7, 5:1:0.7, 1:4:0.6, 1:3:0.6, 1:2:0.6, 1:1:0.6, 2:4:0.6, 2:3:0.6, 2:2:0.6, 2:1:0.6, 3:4:0.6, 3:3:0.6, 3:2:0.6, 3:1:0.6, 4:4:0.6, 4:3:0.6, 4:2:0.6, 4:1:0.6, 5:4:0.6, 5:3:0.6, 5:2:0.6, 5:1:0.6, 1:4:0.5, 1:3:0.5, 1:2:0.5, 1:1:0.5, 2:4:0.5, 2:3:0.5, 2:2:0.5, 2:1:0.5, 3:4:0.5, 3:3:0.5, 3:2:0.5, 3:1:0.5, 4:4:0.5, 4:3:0.5, 4:2:0.5, 4:1:0.5, 5:4:0.5, 5:3:0.5, 5:2:0.5, 5:1:0.5, 1:4:0.4, 1:3:0.4, 1:2:0.4, 1:1:0.4, 2:4:0.4, 2:3:0.4, 2:2:0.4, 2:1:0.4, 3:4:0.4, 3:3:0.4, 3:2:0.4, 3:1:0.4, 4:4:0.4, 4:3:0.4, 4:2:0.4, 4:1:0.4, 5:4:0.4, 5:3:0.4, 5:2:0.4, 5:1:0.4, 1:4:0.3, 1:3:0.3, 1:2:0.3, 1:1:0.3, 2:4:0.3, 2:3:0.3, 2:2:0.3, 2:1:0.3, 3:4:0.3, 3:3:0.3, 3:2:0.3, 3:1:0.3, 4:4:0.3, 4:3:0.3, 4:2:0.3, 4:1:0.3, 5:4:0.3, 5:3:0.3, 5:2:0.3, 5:1:0.3, 1:4:0.2, 1:3:0.2, 1:2:0.2, 1:1:0.2, 2:4:0.2, 2:3:0.2, 2:2:0.2, 2:1:0.2, 3:4:0.2, 3:3:0.2, 3:2:0.2, 3:1:0.2, 4:4:0.2, 4:3:0.2, 4:2:0.2, 4:1:0.2, 5:4:0.2, 5:3:0.2, 5:2:0.2, and 5:1:0.2 (w/w).

Preferred terpenes and/or terpenoids are monoterpenes and/or monoterpenoids such as geraniol/geranyl, thymol, myrcene, menthol, carvone, carvacrol, hinokitiol, linalool, bornyl acetate, citronellal, citronellol, citral, eucalyptol, camphene, camphor, pinene, carene, eugenol and limonene.

A composition according to the invention may further comprise one or more agriculturally acceptable carriers. Said agriculturally acceptable carrier preferably is or includes a pH-stabilizer, an anti-freezing agent, an anti-foam forming agent, and/or a thickening and structuring agent. The addition of small amounts of one or more agriculturally acceptable carriers may affect, preferably improve, parameters such as stability and/or efficacy of a composition according to the invention. The addition of small amounts of one or more agriculturally acceptable carriers preferably increases stability, efficacy and/or rainfastness of a composition according to the invention.

A pH stabilizer, when present, is preferably selected from carboxylic acids such as citric acid, acetic acid, and/or orthophosphoric acid, and suitable salts thereof. A composition of the invention may also comprise two or more different stabilizers. A pH stabilizer is preferably present in an amount of between 0 to up to 10% (w/v), more preferred between 0.01 to up to 5% (w/v), more preferred between 0.02 to up to 1% (w/v), more preferred about 0.05% (w/v).

An antifreezing agent, when present, is preferably selected from glycerine, ethylene glycol, hexyleneglycol and propylene glycol. A composition of the invention may also comprise two or more different antifreezing agents. An antifreezing agent is preferably present in an amount of between 0 to up to 10% (w/v), more preferred between 0.01 to up to 5% (w/v), more preferred between 0.02 to up to 1% (w/v), more preferred about 0.05% (w/v).

An anti-foam forming agent, when present, is preferably selected from polymethylsiloxane, polydimethylsiloxane, simethicone octanol, and silicone oils. A composition of the invention may also comprise two or more different anti-foam forming agents. An anti-foam forming agent is preferably present in an amount of between 0 to up to 10% (w/v), more preferred between 0.05 to up to 5% (w/v), more preferred between 0.1 to up to 1% (w/v), more preferred about 0.5% (w/v).

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.5% (w/v).

In some embodiments, the composition further includes one or more physical stabilizers and/or additives such as buffering agents such as ammonia, ammonium phosphate, potassium phosphate, sodium acetate and potassium hydrogen phthalate, acidifiers such as citrate and phosphoric acid, and drift retardants such as (1) self-emulsifiable esters (produced by the polymerization of oleic and linoleic acids), (2) esters prepared by esterification of ethoxylated trimethylolpropane by fatty acids and dicarboxylic acid anhydrides; (3) esters derived from high molecular weight dibasic acids, polyoxyalkylene glycols and monofunctional aliphatic alcohols; (4) self-emulsifying ester compounds prepared by reacting an ethoxylated trimethylol propane with a carboxylic acid or a reactive derivative thereof; polyethylene glycol with a very high molecular weight and mixtures thereof, pigments such as color coat red seed pigment (BASF), Becker Underwood purple dispersion seed pigment, Becker Underwood seed gloss seed pigment, safeners such as CSI Safener 500FS (Bayer Crop Science), benzoxazine, benzhydryl derivatives, N,N-diallyl dichloroacetamide, various dihaloacyl, oxazolidinyl and thiazolidinyl compounds, ethanone, naphthalic anhydride compounds, and oxime derivatives, and preservatives such as, for example, a sorbate salt for example potassium sorbate, a propionate salt such as sodium propionate or calcium propionate, a benzoate salt such as sodium benzoate or potassium benzoate, an isothiazolone including a mixture of two or more isothiazolinones such as a mixture of 5-chloro-2-methyl-4-isothiazolin-3-one and 2-methyl-4-isothiazolin-3-one, or a mixture of 1,2-benzisothiazolin-3-one and 2-methyl-4-isothiazolin-3-one, or a mixture thereof.

A composition according to the invention may further comprise an agrochemical, such as an additional fungicide, an insecticide, an acaricide, a nematicide, an herbicide, a biostimulant, and/or a bactericide, as detailed herein below.

### Methods of Use

The invention further provides a method for protecting a food product, agricultural plant or agricultural plant part comprising providing a composition according to the invention, and applying said composition to an agricultural plant or plant part such that the agricultural plant or agricultural plant part is contacted with a sufficient amount of said composition.

Said method preferably is for protecting the food product, plant or plant part from a fungus, including ascomycetes and basidiomycetes, preferably from a mould such as Aspergillus, Penicillium, Rhizopus, Fusarium, and Botrytis. A composition of the invention is surprisingly also very active against fungi-like organisms such as oomycetes, including Phytophthora, Pythium, downy mildews (Peronosporaceae), and Albuginales.

The invention further provides a method for improving the development and/or yield of an agricultural plant, comprising providing a composition according to the invention, and contacting the plant with said composition.

A composition of the invention can be applied in many different ways. For example, said composition can be applied by: (1) spraying plants in the field or in greenhouses optionally using a carrier such as a wax or an oil; (2) dipping seeds, bulbs or seed-potatoes; (3) adding to a plant part such as a seed or root system e.g. via the soil (e.g. in-furrow application); (4) adding to a plant part such as a seed, seed-potato or bulb via a seed coating, a seed dressing or a seed pelleting; (5) adding to the soil or growth substrate in which the seeds are to be planted or germinating and/or plants or mushrooms are developing; (6) adding to water or watering systems applied in e.g. greenhouses or in the field; (7) treating harvested plant parts such as bulbs, seeds, cereals, soybeans, flowers, fruit, vegetables or plants by e.g. dipping, mixing, or spraying.

A composition of the invention can be applied without diluting or after dilution. Usually the composition of the invention will be applied via an aqueous or oil dilution, via spraying, a dressing, coating or a wax. A composition according to the invention is preferably diluted prior to the application on a plant or plant part. A composition of the invention can be created in a mixing tank (such as for spraying) by adding the components of the composition. A composition of the invention may be diluted with water, for example in a tank mix. In addition, further agricultural products may be added to the tank mix, for example for application of multiple active ingredients on a food product, an agricultural plant or agricultural plant part, a soil and/or growth substrate, in a single pass.

A composition according to the invention is preferably diluted up to 2 fold or up to 100 fold for seed treatment. A composition according to the invention is preferably diluted between 10 and 106 times in an aqueous solution or in oil, for other applications in the methods of the invention. It will be understood by a person skilled in the art that the required amount of the composition of the invention will differ per application as different applications may require different treatments. In general, however, the amount of composition in a ready-to-use composition such as e.g. a dipping or spraying suspension, calculated back to the amount of natamycin in the composition, required to treat the product (e.g. a growth substrate, a soil, a seed, a bulb, a plant in the field or a harvested fruit) will be 10-300,000 ppm of natamycin, more preferably 30-50.000 ppm of natamycin and most preferably 50-5000 ppm of natamycin.

The final amount of natamycin in a soil or growth medium, on a plant or on a harvested plant part can be expressed in different ways. For example, the amount of natamycin on e.g. a seed applied via e.g. a seed dressing or a seed coating may be 0.001 to 10 grams of natamycin per kg of seed, more preferably 0.01-5 grams of natamycin per kg of seed, most preferably 0.02-0.5 grams of natamycin per kg of seed. A composition of the invention for immersion or spraying of products such as flower bulbs, seed-potatoes, onions, apples, pears, bananas and pineapples may generally comprise 0.01 g/l to 100 g/l, preferably 0.03 g/l to 50 g/l and most preferably 0.05 g/l to 5 g/l of natamycin. The amount of natamycin on a product such as a flower bulb, seed-potato, onion, apple, pear, banana or pineapple, typically is 0.01-20.0 mg/dm²; preferably 0.1-10.0 mg/dm².

In case of treatment of a growth substrate such as a mushroom growth substrate, each spray treatment will add 0.01-5.0 grams of natamycin per m² of growth substrate, more preferably 0.02-1.0 grams of natamycin per m² of growth substrate.

In case of treatment of a soil in which e.g. vegetables or ornamental plants are or will be grown, 0.01-5.0 grams of natamycin may be applied per m², more preferred 0.1-1.0 grams of natamycin per m². Said amount is preferably mixed in the top layer of the soil. In case of a spray application on a crop in the field a typical dosage is 1-5000 grams of natamycin per hectare, more preferably 50-2000 grams per hectare. However, for a crop such as bananas, the preferred dosage of natamycin is 5-500 grams per hectare, more preferably 10-100 grams per hectare.

A composition of the invention can be added at any suitable time using any suitable method to the growth medium, soil, plant or plant part; e.g. before, during or after planting of e.g. a seed, bulb, seed-potato, a cutting or a young plant; during growth in the field, after harvesting or during storage of a fruit, vegetable, nut or flower bulb.

An antifungal composition according to the invention is suitable for the control of pests that are encountered in horticulture, agriculture, and forestry. The antifungal composition is active against normally sensitive and resistant pest species and during all or individual stages of development. Prior to use, a composition comprising an antifungal composition according to the invention is preferably dissolved or dispersed in water, or diluted with water, to provide an aqueous composition comprising between 0.001 and 10 w/v % of the bioactive natamycin. If required, an agriculturally acceptable carrier such as a sticking agent is added to the diluted aqueous composition.

A composition according to the invention is preferably diluted 2-5000 times, preferably about 200 times, with an aqueous solvent, preferably water, to contain between 0.0001 and 10% (w/v) of the natamycin, prior to contacting a plant, plant part or soil with the composition.

To control agricultural pests, the invention provides a use of a composition according to the invention for the protection of a plant, or a part of a plant, against a pathogen. In order to achieve this effect, said plant or plant part, or a soil, is contacted with said composition, including the diluted aqueous composition as described herein above. Said composition may be used, for example, to control powdery mildew and Botrytis infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, Fusarium diseases, peanut leafspot, and mildew on roses.

Further use of a composition according to the invention is, for example, to control late blight, including potato late blight and/or tomato late blight. Further use, for example, is to control downy mildew disease, such as downy mildew of grape (Plasmopara viticola), downy mildew of curcubits, downy mildew of spinach, downy mildew of lettuce (Bremia lactucae). Further use, for example, is to control damping off or root rot diseases caused by Pythium and Phytophthora species, such as damping off of spinach, corn and soybeans.

Other uses include protection of greenhouse grown flowers and ornamentals, home vegetable gardens and residential turf. In addition, said composition, including a diluted aqueous composition, may be contacted with isolated seeds, fruits, nuts, vegetables, and/or flowers.

The invention further provides a method of protecting a plant or plant part against a pathogen, comprising contacting said plant or said plant part with a diluted aqueous composition according to this invention.

The invention further provides a method of preventing, reducing and/or eliminating the presence of a pathogen on a plant, or a part of a plant, comprising contacting said plant, or part of said plant, with an aqueous composition according to this invention.

For said use and said methods, the composition, including a diluted aqueous composition, is preferably sprayed over a plant, or part thereof. Spraying applications, including the use of automatic spraying systems are known to reduce labor costs and are cost-effective. Methods and equipment well-known to a person skilled in the art can be used for that purpose. The composition, including diluted aqueous composition, can regularly be sprayed, when the risk of infection is high. When the risk of infection is lower, spray intervals may be longer, as is known to a person skilled in the art.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, injecting, painting, brushing, misting, dusting, foaming, spreading-on, packaging and coating (e.g. by means of wax or electrostatically). In addition, the composition of the invention, including a diluted aqueous composition, may be injected into the soil.

For example, a plant of part thereof may be coated with a diluted aqueous composition according to the invention by submerging the plant or part thereof in a diluted aqueous composition according to the invention, to protect the plant of part thereof against a pathogen and/or to prevent, reduce and/or eliminate the presence of a pathogen on a plant, or a part of a plant.

A preferred part of a plant that is coated with a composition according to the invention, or with a dilution thereof, is seed. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

The invention further provides a method of controlling diseases caused by phytopathogenic fungi in plants or on propagation material thereof, which method comprises contacting the plants, or propagation material thereof, with a composition according to the invention, including an aqueous diluted composition.

The present invention also provides a method of controlling pests comprising contacting (i) a pest or a locus thereof, (ii) a plant or a locus or propagation material thereof, (iii) soil, and/or (iv) an area in which a pest infestation is to be prevented with a composition of the invention.

The present invention also provides a method for improving pest control comprising applying a composition described herein to a plant/or soil.

The present invention also provides a method for prolonging a controlling effect of natamycin on a plant, plant part or soil, comprising applying a composition of the invention or dilution thereof, to the plant, plant part or soil.

In some embodiments, the target is a plant, plant part, soil or growth substrate. In some embodiments, the target is a fungus or fungus-like organism such as an oomycete.

The present invention also provides a method for pest control by preventive, curative or persistence treatment of a plant disease caused by phytopathogenic fungi comprising contacting a plant, a locus thereof or propagation material thereof with an effective amount of a composition according to the invention.

A composition according to the invention may be applied to healthy or diseased plants. The described compositions can be used on various plants including but not limited to crops, seeds, bulbs, propagation material, or ornamental species.

The present invention provides a method of controlling a disease caused by phytopathogenic fungi on plants or propagation material thereof, comprising contacting the plants, the locus thereof or propagation material thereof with a composition according to the invention.

In some embodiments, a composition according to the invention is applied at a rate effective for controlling a pest. In some embodiments, a composition according to the invention is applied at a rate effective for preventing infestation of the pest. In some embodiments, a composition according to the invention is applied at a rate effective for curing infestation of the pest.

In some embodiments, a method of the invention is effective for preventing infestation of a pest. In some embodiments, the method is effective for curing infestation of the pest. In some embodiments, the method is effective for increasing the pesticidal activity of natamycin. In some embodiments, the method is effective for prolonging the pesticidal effect of natamycin.

In some embodiments, a method of the invention further comprises applying at least one additional agrochemical to a pest, a plant part, a plant, a locus, or propagation material thereof. Said additional agrochemical may be admixed in a tank, or applied sequentially with a composition of the invention to the plants, plant parts, soil or growth substrate.

Said additional agrochemical may be one or more of an additional fungicide, an insecticide, an acaricide, a nematicide, a herbicide, a biostimulant, and/or a bactericide.

Examples of a suitable additional fungicide are presented in the Fungicide Resistance Action Committee (FRAC) document (FRAC Code List© 2023, available at frac.info), including a compound such as a conazole fungicide such as, for example, (RS)-1-(B-allyloxy-2,4-dichlorophenethyl) imidazole (imazalil; Janssen Pharmaceutica NV, Belgium) and N-propyl-N-[2-(2,4,6-trichlorophenoxy)ethyl] imidazole-1-carboxamide (prochloraz), a thiazole fungicide such as, for example, 2-(thiazol-4-yl)benzimidazole (thiabendazole; e.g. the commercial product TECTO® Flowable SC of Syngenta, USA), methyl 1-(butylcarbamoyl)benzimidazol-2-ylcarbamate (benomyl), a nonsystemic phthalimide fungicide such as, for example, N-(trichloromethylthio)cyclohex-4-ene-1,2-dicarboximide (captan), N-(trichloromethylthio) phthalimide (folpet) (commercial product FOLPAN® (Makhteshim Agan International)), a carbamate fungicide such as, for example, dimethyl 4,4′-(o-phenylene)bis(3-thioallophanate) (thiophanate-methyl; commercial product: TOPSIN® M (Cerexagri Inc), phosphite (salt and ester of phosphoric acid, H₃PO₃) and a pyridine fungicide such as, for example, 3-chloro-N-(3-chloro-5-trifluoromethyl-2-pyridyl)-α,α,α-trifluoro-2,6-dinitro-p-toluidine (fluazinam; commercial product: SHIRLAN®, Syngenta, Switserland). Most preferred additional fungicides are sulfur and/or phosphite. A composition of the invention may also comprise two or more fungicides.

Examples of a suitable insecticide are presented in the Insecticide Resistance Action Committee (IRAC) document (available at IRAC-online.org), including imidacloprid (commercial product: ADMIRER, Bayer), Bacillus thuringiensis (commercial product: TUREX®, Certis USA), teflubenzuron (commercial product: NOMOLT®, BASF), pymetrozine (commercial product: PLENUM®, Syngenta), pyrethroids/pyrethrone/permethrin (commercial product PERMETHRIN SFR®, Adama), chlorfenapyr (commercial product SPECTRE® Adama), and acetamiprid (commercial product: GAZELLER, Certis Europe). A most preferred insecticide is imidacloprid. A composition of the invention may also comprise two or more insecticides.

Examples of a suitable acaricide include chlofentezine (commercial product: APOLLO®, Makhteshim), acequinocyl (commercial product: KAMEMYTE®, Arysta), spirodiclofen (commercial product: ENVIDOR®, Bayer CropScience), bifenazate (commercial product: FLORAMITER, Certis Europe) and fenbutatinoxide (commercial product: TORQUE L®, BASF). A most preferred acaricide is spirodiclofen. A composition of the invention may also comprise two or more acaricides.

Examples of a suitable nematicide include abamectin, dazomet, chloropicrin, 1,3-dichloropropene, ethoprop, fosthiazate, fluopyram, spirodiclofen, predatory nematodes, and Bacillus firmus.

Examples of a suitable herbicide include glyphosate, 2,4-D, dicamba, pendimethalin, glufosinate, clethodim, atrazine, clomazone, acifluorfen, metsulfuron and sulfentrazone.

Examples of a suitable biostimulant include seaweed extracts (e.g., an Ascophyllum nodosum extract), humic acid (e.g., potassium humate), fulvic acid, myo-inositol, and/or glycine. A composition of the invention may also comprise two or more biostimulants.

Examples of a suitable bactericide include compounds such as copper salts (e.g. copper hydroxide, copper oxychloride, copper sulfate and Bordeaux mixture), streptomycin, the commercial product CITRICIDAL® (Bio/Chem Research) and validamycin. A most preferred bactericide is copper hydroxide. A composition of the invention may also comprise two or more bactericides.

The invention is illustrated by the following examples without limiting it thereby.

### EXAMPLES

### General

### 1. Natamycin Formulation Used in the Experiments.

Natamycin was tested in different test systems at different concentrations as indicated in each example. In these experiments, natamycin was formulated as shown in Table 1.

TABLE 1
Natamycin formulation used in the examples. Provided are the
range of ingredients used in the different experiments.

| Formulation | Gram/Liter |
|---|---|
| Natamycin | 150 |
| Polyol | 175-300 |
| Wetting agent | 20-30 |
| Dispersing agent | 5-15 |
| Antifoam | 0.5-10 |
| Mixture of isothiazolinones | 0.05-0.3 |
| Xanthan gum (2% in water) | 70-85 |
| Water | 509.7-679.45 |
| Total | 1100 |

### 2. Determination of Synergy

In some instances, the stimulation of the antifungal activity of natamycin by a solvent was found to be synergistic. The Colby equation (Colby, 1967. Weeds 15: 20-22) calculates the expected antifungal activity (E in %) of a combination comprising more than one active ingredients:

$$E = X + Y - [ ( X \cdot Y ) / 100 ]$$

wherein X and Y are the observed antifungal activities (in %) of the individual active ingredients x and y, respectively. If the observed antifungal activity (O in %) of the combination exceeds the expected antifungal activity (E in %) of the combination and the synergy factor O/E is thus >1.0, the combined application of the active ingredients and solvent leads to a synergistic antifungal effect.

### Example 1: Effect of Water-Immiscible Solvent n-Butyl L-Lactate on Natamycin Efficacy on Pythium ultimum Infection Tested on Petri Dishes

In this experiment, the product Purasolv BL® (Corbion) containing the water-immiscible solvent n-butyl L-lactate was tested.

### Materials and Methods

Agar medium was prepared by mixing in a 100 ml Duran bottle 3.9 g of potato dextrose agar (PDA; Carl-Roth GmbH+Co. KG, Karlsruhe, Germany) with 100 ml deionized water and autoclaving the Duran bottle at 120° C. for 15 minutes. After autoclaving, the solution was cooled by putting it in a 50° C. oven for about two hours. Afterward the semi-liquid PDA solution was carefully mixed with natamycin and/or solvent dosages as specified in Table 2 (left column). The medium in the Duran bottle was divided over 5 petri dishes (90×15 mm), 20 ml per petri dish by using 25 ml serological pipets (ROTILABO®; Carl-Roth). Each natamycin and/or solvent treatment was performed in five fold.

Hereafter, a circular agar mycelium plug (circular segment with a height on 5 mm of agar, fully grown with fresh Pythium ultimum mycelium, which was cut out of a petri dish with the broad side of a yellow pipette tip (Greiner Bio-One, 200 μl tips) with a diameter of 5 mm, was placed in the center of the petri dish. Hereafter the petri dishes were placed in the incubator at 22° C. Measurement of the fungal growth was done using caliper.

The solvent levels and the period after which the assessments were made are presented as specified for the different solvents are presented in Table 2 below. Synergistic calculation was done using the Colby equation. Experiment was performed in 5-fold.

### Results

Results are presented in Table 2, measurements were performed 2 days after placing the mycelium plug. It is concluded that a combination of natamycin and water-immiscible solvent n-butyl L-lactate has a synergistic effect against the oomycete Pythium ultimum at ratios from 1:2.5 to 1:10 (w/w; natamycin:n-butyl L-lactate).

TABLE 2
Antifungal effect of natamycin in combination with
water-immiscible solvent n-Butyl L-lactate
(Purasolv BL ®) against Pythium ultimum
infection tested on petri dishes.

| | Avg | | | | |
|---|---|---|---|---|---|
| Natamycin - | infected | | | | |
| solvent | area | | | | |
| (ppm) | (mm²) | Observed % | Expected % | O/E | Interaction |
| 0-0 | 4751.619 | 0.00 | | | |
| 25-0 | 4535.536 | 4.55 | | | |
| 0-62.5 | 4351.905 | 8.41 | | | |
| 0-125 | 4273.45 | 10.06 | | | |
| 0-250 | 3229.281 | 32.04 | | | |
| 25-62.5 | 3851.349 | 18.95 | 12.58 | 1.5 | Synergism |
| 25-125 | 3566.93 | 24.93 | 14.15 | 1.8 | Synergism |
| 25-250 | 2779.916 | 41.50 | 35.13 | 1.2 | Synergism |

### Example 2: Effect of Water-Immiscible Solvent n-Butyl L-Lactate on Natamycin Efficacy on Pythium ultimum Infection Tested on Petri Dishes

In this experiment, the product Purasolv BL® (Corbion) containing the water-immiscible solvent n-butyl L-lactate was tested. The solvent levels and the period after which the assessments were made are presented as specified in Table 3 below.

### Results

Results are presented in Table 3, measurements were performed 2 days after placing the mycelium plug. It is concluded that a combination of natamycin and water-immiscible solvent n-butyl L-lactate has a synergistic effect against the oomycete Pythium ultimum at a ratio of about 1:5 (w/w; natamycin:n-butyl L-lactate).

TABLE 3
Antifungal effect of natamycin in combination with
water-immiscible solvent n-Butyl L-lactate
(Purasolv BL ®) against Pythium ultimum
infection tested on petri dishes.

| | Avg | | | | |
|---|---|---|---|---|---|
| Natamycin - | infected | | | | |
| solvent | area | Ob- | Expec- | | |
| (ppm) | (mm²) | served % | ted % | O/E | Interaction |
| 0-0 | 5414.358 | 0.00 | | | |
| 100-0 | 4435.301 | 18.08 | | | |
| 200-0 | 5059.918 | 6.55 | | | |
| 0-500 | 2356.853 | 56.47 | | | |
| 0-1000 | 846.8886 | 84.36 | | | |
| 100-500 | 1896.856 | 64.97 | 60.67 | 1.1 | Synergism |
| 200-1000 | 269.6602 | 95.02 | 85.87 | 1.1 | Synergism |

### Example 3: Effect of Water-Miscible Solvent Dimethyl Sulfoxide (DMSO) on Natamycin Efficacy on Pythium ultimum Infection Tested on Petri Dishes

In this experiment, the water-miscible solvent DMSO was tested as described in Example 1. The solvent levels and the period after which the assessments were made are presented as specified in Table 4 below.

### Results

Results are presented in Table 4, measurements were performed 2 days after placing the mycelium plug. It is concluded that a combination of natamycin and water-miscible solvent DMSO has no synergistic effect against the oomycete Pythium ultimum at a ratio of about 1:5 (w/w; natamycin:DMSO).

### Example 4: Effect of Water-Miscible Solvent Ethanol (EtOH) on Natamycin Efficacy on Pythium ultimum Infection Tested on Petri Dishes

In this experiment, the water-miscible solvent EtOH was tested as described in Example 1. The natamycin-solvent ratios and the period after which the assessments were made are presented as specified in Table 5 below.

### Results

Results are presented in Table 5, measurements were performed 2 days after placing the mycelium plug. It is concluded that a combination of natamycin and water-miscible solvent EtOH has no synergistic effect against the oomycete Pythium ultimum at a ratio of about 1:5 (w/w; natamycin:EtOH).

TABLE 4
Antifungal effect of natamycin in combination
with water-miscible solvent DMSO against Pythium ultimum
infection tested on petri dishes.

| | Avg | | | | |
|---|---|---|---|---|---|
| Natamycin - | infected | | | | |
| solvent | area | Ob- | Expec- | | |
| (ppm) | (mm2) | served % | ted % | O/E | Interaction |
| 0-0 | 5414.358 | 0.00 | | | |
| 25-0 | 4397.811 | 18.78 | | | |
| 50-0 | 4891.484 | 9.66 | | | |
| 100-0 | 4435.301 | 18.08 | | | |
| 200-0 | 5059.918 | 6.55 | | | |
| 0-125 | 5247.969 | 3.07 | | | |
| 0-250 | 5238.583 | 3.25 | | | |
| 0-500 | 5129.162 | 5.27 | | | |
| 0-1000 | 4475.89 | 17.33 | | | |
| 25-125 | 5296.25 | 2.18 | 21.27 | 0.1 | No synergism |
| 50-250 | 4995.27 | 7.74 | 12.59 | 0.6 | No synergism |
| 100-500 | 5302.612 | 2.06 | 22.40 | 0.1 | No synergism |
| 200-1000 | 4557.852 | 15.82 | 22.74 | 0.7 | No synergism |

TABLE 5
Antifungal effect of natamycin in combination
with water-miscible solvent EtOH against Pythium ultimum
infection tested on petri dishes.

| | Avg | | | | |
|---|---|---|---|---|---|
| Natamycin - | infected | | | | |
| solvent | area | Ob- | Expec- | | |
| (ppm) | (mm2) | served % | ted % | O/E | Interaction |
| 0-0 | 5414.358 | 0.00 | | | |
| 25-0 | 4397.811 | 18.78 | | | |
| 50-0 | 4891.484 | 9.66 | | | |
| 100-0 | 4435.301 | 18.08 | | | |
| 0-125 | 5488.804 | −1.37 | | | |
| 0-250 | 5286.064 | 2.37 | | | |
| 0-500 | 4366.453 | 19.35 | | | |
| 25-125 | 4838.037 | 10.64 | 17.66 | 0.60 | No synergism |
| 50-250 | 5005.713 | 7.55 | 11.80 | 0.64 | No synergism |
| 100-500 | 4941.129 | 8.74 | 33.94 | 0.26 | No synergism |

### Example 5: Effect of Water-Immiscible Solvent 2-ethylhexyl L-Lactate (EHL) on Natamycin Efficacy on Pythium ultimum Infection Tested on Petri Dishes

In this experiment, the product Purasolv EHL® (Corbion) containing the water-immiscible solvent 2-ethylhexyl L-lactate was tested as described in Example 1. The solvent levels and the period after which the assessments were made are presented as specified in Table 6 below.

### Results

Results are presented in Table 6, measurements were performed 1 day after placing the mycelium plug. It is concluded that a combination of natamycin and water-immiscible solvent EHL has a synergistic effect against the oomycete Pythium ultimum at ratios from 1:5 to 1:10 (w/w; natamycin:EHL).

TABLE 6
Antifungal effect of natamycin in combination with
water-immiscible solvent EHL against Pythium ultimum
infection tested on petri dishes.

| | Avg | | | | |
|---|---|---|---|---|---|
| Natamycin - | infected | | | | |
| solvent | area | Ob- | Expec- | | |
| (ppm) | (mm2) | served % | ted % | O/E | Interaction |
| 0-0 | 1884.142 | 0.00 | | | |
| 25-0 | 1738.438 | 7.73 | | | |
| 0-125 | 290.1899 | 84.60 | | | |
| 0-250 | 34.77633 | 98.15 | | | |
| 25-125 | 135.6566 | 92.80 | 85.79 | 1.1 | Synergism |
| 25-250 | 6.380245 | 99.66 | 98.30 | 1.0 | Synergism |

### Example 6: Effect of Water-Miscible Solvent Ethyl L-Lactate (EL) on Natamycin Efficacy on Pythium ultimum Infection Tested on Petri Dishes

In this experiment, the product Purasolv EL® (Corbion) containing the water-miscible solvent ethyl L-lactate was tested as described in Example 1. The solvent levels and the period after which the assessments were made are presented as specified in Table 7 below.

### Results

Results are presented in Table 7, measurements were performed 1 day after placing the mycelium plug. It is concluded that a combination of natamycin and water-miscible solvent EL has no synergistic effect against the oomycete Pythium ultimum at ratios of between 1:0.5 to 1:2 (w/w; natamycin:EL).

TABLE 7
Antifungal effect of natamycin in combination
with water-miscible solvent EL against Pythium ultimum
infection tested on petri dishes.

| | Avg | | | | |
|---|---|---|---|---|---|
| Natamycin - | infected | | | | |
| solvent | area | Ob- | Expec- | | |
| (ppm) | (mm2) | served % | ted % | O/E | Interaction |
| 0-0 | 549.1861 | 0.00 | | | |
| 25-0 | 639.0893 | −16.37 | | | |
| 50-0 | 563.7967 | −2.66 | | | |
| 0-12.5 | 625.9774 | −13.98 | | | |
| 0-25 | 574.2358 | −4.56 | | | |
| 0-50 | 619.378 | −12.78 | | | |
| 25-12.5 | 518.389 | 5.61 | −32.64 | −0.2 | No synergism |
| 25-50 | 565.5437 | −2.98 | −31.24 | 0.1 | No synergism |
| 50-50 | 614.1245 | −11.82 | −15.78 | 0.7 | No synergism |

### Example 7: Effects of Water-Miscible Solvents Ethanol (EtOH), Ethyl L-Lactate (EL) and Water-Immiscible Solvent 2-ethylhexyl L-Lactate (EHL) on Natamycin Efficacy on Botrytis cinerea Infection Tested on Petri Dishes

In this experiment, the products Purasolv EL® and Purasolv EHL (Corbion) containing the water-miscible solvent Ethyl L-lactate, and the water-immiscible solvent 2-Ethylhexyl L-lactate (EHL), respectively, were tested as described in Example 1. In addition, the water-miscible solvent EtOH was also tested. The solvents levels and the period after which the assessments were made are presented as specified in Table 8 below.

### Results

Results are presented in Table 8, measurements were performed 1 day after placing the mycelium plug. It is concluded that a combination of natamycin and water-miscible solvents EL and EtOH have no synergistic effect against the fungus Botrytis cinerea at a ratio of 1:1 (w/w; natamycin:solvent). In contrast the combination of natamycin and water-immiscible solvent EHL has a synergistic effect against the fungus Botrytis cinerea at a ratio of 1:1 (w/w; natamycin:EHL).

TABLE 8
Antifungal effect of natamycin in combination with
water-miscible solvents EL and EtOH, and in combination
with water-immiscible solvent EHL against Botrytis cinerea
infection tested on petri dishes.

| | Avg | | | | |
|---|---|---|---|---|---|
| | infected | | | | |
| | area | Ob- | Expec- | | |
| | (mm2) | served % | ted % | O/E | Interaction |
| Natamycin - | | | | | |
| EtOH (ppm) | | | | | |
| 0-0 | 1971.548 | 0.00 | | | |
| 0.5-0 | 1183.171 | 39.99 | | | |
| 0-0.5 | 1602.867 | 18.70 | | | |
| 0.5-0.5 | 1206.705 | 38.79 | 51.21 | 0.8 | No synergy |
| Natamycin - | | | | | |
| EL (ppm) | | | | | |
| 0-0 | 1971.548 | 0.00 | | | |
| 0.5-0 | 1183.171 | 39.99 | | | |
| 0-0.5 | 1390.376 | 29.48 | | | |
| 0.5-0.5 | 994.5072 | 49.56 | 57.68 | 0.9 | No synergism |
| Natamycin - | | | | | |
| EHL (ppm) | | | | | |
| 0-0 | 1971.548 | 0.00 | | | |
| 0.5-0 | 1183.171 | 39.99 | | | |
| 0-0.5 | 1740.142 | 11.74 | | | |
| 0.5-0.5 | 968.4149 | 50.88 | 47.03 | 1.1 | Synergism |

### Example 8: Effect of Water-Immiscible Solvent n-butyl L-Lactate on Natamycin and Thymol Efficacy Against Pythium ultimum on Seeds in Artificially Infected Soil

### Materials and Methods

Seeds were coated with a natamycin formulation as described in Table 1, in the presence or absence of solvent and thymol (see Table 9). Spinach seeds were placed in soil that was artificially infected (see below for method).

Soil infection was obtained via incubation of soil with infected, killed rye seeds. For this, 50 g of rye seeds and 50 ml water were put into a 500 ml glass jar, which was autoclaved twice (121° C., 15 min, 15 psi). The dead rye seeds were infected with Pythium ultimum PDA plugs (circular segments of PDA, covered with freshly fully grown Pythium ultimum mycelium, which were cut out of a petri dish with the broad side of a yellow pipette tip (Greiner Bio-One, 200 μl tips) with a diameter of 5 mm). Three P. ultimum agar plugs were placed in the 500 ml jar containing the 50 g autoclaved (dead) rye seeds, which was further incubated at 22° C. for one week (16 h day light, 8 hours dark). To prepare the infected soil, potting soil (Tuinaarde, ophoog grond, purchased from Welkoop) were placed in round transparent plastic containers (9 cm in diameter, 4.5 cm high, volume 250 ml). Ten infected rye seeds, that acted as a carrier for P. ultimum, were placed in each round plastic container. To treat the spinach seeds, 77.8 μl of treatment mix (see below) was added to 1 g of seeds in a plastic container. The seeds were shaken and let to dry. Once dried, 20 treated spinach seeds were added to the inoculated soil. The rye seeds and spinach seeds were mixed into the soil, so that both seed types were homogenously distributed within the soil as well as covered by the soil. The containers were closed with transparent lids and placed into a growth cabinet with the following growth conditions: 16 h day light, 22° C. constant temperature, 70% humidity. Emergence of the seedlings was assessed. For each treatment 3 pots were used, resulting in 3 replicates.

### Treatments

For 1 g of spinach seeds: 0.25 mg natamycin according to the formulation as described in Table 1 was mixed (or not in the control) to 0.0625 mg thymol, to 24.60 μl of red colorant for seed treatment and water was added accordingly to reach a total volume of 77.8 μl. The ratio natamycin:thymol used was about 1:0.25 (w/w). Previous to mixing in the user solution, thymol was dissolved in the water-immiscible solvent n-butyl L-lactate (BL) at concentrations of 10, 20, 100 and 200 g thymol per Liter of BL; the amount of water-immiscible solvent applied on the seeds was consequently 6.25, 3.12, 0.62, and 0.31 mg per g of seeds (Table 9). As control treatment without natamycin nor thymol was used.

### Results

Results are presented in Table 9, number of emerged spinach seedlings was recorded 6 days after sowing. It is concluded that a combination of natamycin, thymol and water-immiscible solvents BL has a synergistic effect against Pythium ultimum at ratio's from 1:25:0.25 to 1:1.24:0.25 (w/w; natamycin:solvent:thymol).

### Example 9: Effect of Water-Miscible Solvent Ethanol on Natamycin and Thymol Efficacy Against Pythium ultimum on Seeds in Artificially Infected Soil

In this experiment, EtOH was tested with natamycin and thymol as described in Example 8 and with the following specifics: radish seeds and Pythium ultimum were used. For 1 g of seeds 0.05 mg natamycin according to the formulation as described in Table 1 was mixed (or not in the control) with 0.0125 mg thymol, with 4.92 μl of red colorant for seed treatment. Water was added accordingly to reach a total volume of 15.56 μl. The ratio natamycin:thymol was about 1:0.25 (w/w). Previous to mixing in the user solution, thymol was dissolved in the water-miscible solvent EtOH at concentrations of 10, 20, and 200 g thymol per liter of EtOH; the amount of water-miscible solvent applied on the seeds was consequently 1.25, 0.62, and 0.06 mg per g of seeds (see Table 10). As control treatment without natamycin nor thymol was used.

### Results

Results are presented in Table 10, number of emerged radish seedlings was recorded 2 days after sowing. It is concluded that a combination of natamycin, thymol and water-miscible solvent EtOH have no synergistic effect against Pythium ultimum at ratio's from 1:25:0.25 to 1:1.2:0.25 (w/w; natamycin:solvent:thymol).

### Example 10: Effects of Water-Immiscible Solvent n-Butyl L-Lactate on Natamycin and Geraniol Efficacy on Pythium ultimum Infection Tested on Petri Dishes

In this experiment, the product Purasolv BLR (Corbion) containing the water-immiscible solvent n-butyl L-lactate, and geraniol dissolved in water-miscible solvent EtOH at a concentration of 200 g/L, were tested as described in Example 1. The amount of each compounds and the period after which the assessments were made are presented as specified in Table 11 below.

### Results

Results are presented in Table 11, measurements were performed 1 day after placing the mycelium plug. It is concluded that combinations of natamycin and the water-immiscible solvent n-butyl L-lactate have a synergistic effect against P. ultimum at ratio's from 1:2.5 to 1:10 (w/w; natamycin:solvent). When combining natamycin to geraniol dissolved in the water-miscible solvent EtOH, no synergistic effect was observed at a ratio of 1:2.5:0.5 (w/w; natamycin:EtOH:geraniol). Surprisingly when adding to this non-synergistic combination of natamycin-geraniol the water-immiscible solvent BL, synergistic effects were observed at ratio's from 1:2.5:0.5 to 1:10:0.5 (w/w; natamycin:solvent:geraniol). The synergistic effects observed in the natamycin, geraniol, BL combination was much higher than observed for the combination of natamycin and BL alone (Table 11). These results show that, in the presence of a Wis, the fungicidal activity of a second active ingredient, such as the terpernoid geraniol, when combined with natamycin, is synergistically enhanced.

### Example 11: Solubility of Natamycin in Water-Immiscible Solvent

The solubility of natamycin was measured in water and in the water-miscible solvent DMSO. For this, 240.6 mg and 94.3 mg of natamycin at a purity of 95% (DSM) were diluted in 50 ml of water and DMSO, respectively. The mixtures were sonicated for 30 minutes and analysed by HPLC. The HPLC system was an Agilent 1100 system. The column used was a ACE C18 RP column, 250×4.6 mm with pore size 5 μm. The mobile phase consisted of 1 g ammonium chloride and 3 g ammonium acetate dissolved in 760 mL water, and mixed with 240 mL acetonitrile and 5 mL tetrahydrofuran (THF). The speed of the flow was 3.0 ml/min and the column temperature was 25° C. The injection volume was 20 μL. Natamycin was detected with a spectrophotometer at a wavelength of 303 nm. All samples were centrifugated and filtered through 0.45 μm HPLC filters before analysis. The amount of dissolved natamycin measured in water and DMSO were 32 mg/kg and 2571 mg/kg, respectively (see Table 12).

For the water-miscible solvent Purasolv® EL, and the water-immiscible solvents BL and EHL, natamycin was added until it no longer dissolved. The mixtures were then filtered and analysed by HPLC. The amount of dissolved natamycin were 832, 211, and 271 mg/kg for EL, BL, and EHL, respectively (Table 12).

TABLE 9
Antifungal effect of natamycin and thymol in combination with water-immiscible
solvent n-butyl L-lactate against Pythium ultimum on spinach seeds.

| Natamycin | BL | Thymol | | | | | |
|---|---|---|---|---|---|---|---|
| (mg/g | (mg/g of | (mg/g | Avg | Observed | Expected | | |
| seeds) | seeds) | seeds) | germination | % | % | O/E | Interaction |
| 0 | 0 | 0 | 13.3 | 0.00 | | | |
| 0.25 | 0 | 0 | 18.3 | 37.50 | | | |
| 0 | 6.25 | 0.0625 | 11.7 | −12.50 | | | |
| 0 | 3.12 | 0.0625 | 21.7 | 62.50 | | | |
| 0 | 0.62 | 0.0625 | 6.7 | −50.00 | | | |
| 0 | 0.31 | 0.0625 | 8.3 | −37.50 | | | |
| 0.25 | 6.25 | 0.0625 | 26.7 | 100.00 | 29.69 | 3.37 | Synergism |
| 0.25 | 3.12 | 0.0625 | 33.3 | 150.00 | 76.56 | 1.96 | Synergism |
| 0.25 | 0.62 | 0.0625 | 18.3 | 37.50 | 6.25 | 6.00 | Synergism |
| 0.25 | 0.31 | 0.0625 | 25.0 | 87.50 | 14.06 | 6.22 | Synergism |

TABLE 10
Antifungal effect of natamycin and thymol in combination with water-
miscible solvent EtOH against Pythium ultimum on radish seeds

| Natamycin | EtOH | Thymol | | | | | |
|---|---|---|---|---|---|---|---|
| (mg/g | (mg/g of | (mg/g | Avg | Observed | Expected | | |
| seeds) | seeds) | seeds) | germination | % | % | O/E | Interaction |
| 0 | | 0 | 36.7 | 0.00 | | | |
| 0.05 | | 0 | 41.7 | 13.64 | | | |
| 0 | 1.25 | 0.0125 | 43.3 | 18.18 | | | |
| 0 | 0.62 | 0.0125 | 58.3 | 59.09 | | | |
| 0 | 0.06 | 0.0125 | 43.3 | 18.18 | | | |
| 0.05 | 1.25 | 0.0125 | 40.0 | 9.09 | 29.34 | 0.31 | No synergism |
| 0.05 | 0.62 | 0.0125 | 48.3 | 31.82 | 64.67 | 0.49 | No synergism |
| 0.05 | 0.06 | 0.0125 | 35.0 | −4.55 | 29.34 | −0.15 | No synergism |

TABLE 11
Antifungal effect of natamycin and geraniol in combination with water-immiscible
solvent BL against P. ultimum infection tested on petri dishes.

| Natamycin | BL | Geraniol | EtOH | Avg infected | Observed | Expected | | |
|---|---|---|---|---|---|---|---|---|
| (ppm) | (ppm) | (ppm) | (ppm) | area (mm²) | % | % | O/E | Interaction |
| 0 | 0 | 0 | 0 | 2197.1 | 0.0 | | | |
| 25 | 0 | 0 | 0 | 2003.2 | 8.8 | | | |
| 0 | 62.5 | 0 | 0 | 2296.9 | −4.5 | | | |
| 0 | 125 | 0 | 0 | 2173.6 | 1.1 | | | |
| 0 | 250 | 0 | 0 | 1930.7 | 12.1 | | | |
| 25 | 62.5 | 0 | 0 | 2019.2 | 8.1 | 4.7 | 1.7 | Synergism |
| 25 | 125 | 0 | 0 | 1866.1 | 15.1 | 9.8 | 1.5 | Synergism |
| 25 | 250 | 0 | 0 | 1757.8 | 20.0 | 19.9 | 1.0 | Synergism |
| 0 | 0 | 0 | 0 | 2197.1 | 0.0 | | | |
| 25 | 0 | 0 | 0 | 2003.2 | 8.8 | | | |
| 0 | 0 | 12.5 | 62.5 | 1800.8 | 18.0 | | | |
| 25 | 0 | 12.5 | 62.5 | 2027.5 | 7.7 | 25.3 | 0.3 | No synergism |
| 0 | 0 | 0 | 0 | 2197.1 | 0.0 | | | |
| 25 | 0 | 12.5 | 62.5 | 2027.5 | 7.7 | | | |
| 0 | 62.5 | 0 | 0 | 2296.9 | −4.5 | | | |
| 0 | 125 | 0 | 0 | 2173.6 | 1.1 | | | |
| 0 | 250 | 0 | 0 | 1930.7 | 12.1 | | | |
| 25 | 62.5 | 12.5 | 62.5 | 1807.4 | 17.7 | 3.5 | 5.0 | Synergism |
| 25 | 125 | 12.5 | 62.5 | 1570.6 | 28.5 | 8.7 | 3.3 | Synergism |
| 25 | 250 | 12.5 | 62.5 | 1255.6 | 42.9 | 18.9 | 2.3 | Synergism |

TABLE 12
Amount of dissolved natamycin in water, in the water-miscible
solvents DMSO and ethyl L-lactate, and in the water-immiscible
solvents n-butyl L-lactate and 2-ethylhexyl L-lactate.

| | Natamycin |
|---|---|
| | concentration |
| Solvents | (mg/kg) |
| Water | 32 |
| DMSO | 2571 |
| ethyl L-lactate (Purasolv EL ®) | 832 |
| 2-ethylhexyl L-lactate (Purasolv EHL ®) | 271 |
| n-butyl L-lactate (Purasolv BL ®) | 211 |

In conclusion, the observed synergy between natamycin and the water-immiscible solvents cannot be attributed to an increased solubility of the natamycin itself. This is surprising and unexpected, as the general understanding (see, for example, WO2004082407A) is that natamycin should be more effective when soluble.

### Example 12: Effect of Wis Belonging to the Group of Aliphatic and/or Aromatic Hydrocarbons on Natamycin Efficacy on Pythium ultimum Infection Tested on Petri Dishes

In this experiment, the paraffinic oil product Solvesso™ 200 (ExxonMobil, Table 13), Xylene (Table 14), a dearomatized hydrocarbon Exxsol™ D220/240 (ExxonMobil, Table 14), and the aliphatic hydrocarbon product Isopar™ V (ExxonMobil, Table 15) were tested as described in Example 1. The respective solvent levels are presented in Tables 13-15.

### Results

It is concluded that a combination of natamycin and Wis paraffinic oil have synergistic effects against the oomycete Pythium ultimum at ratios 1:1 and 1:0.5 (Table 13, Table 15). It is concluded that combinations of natamycin and Wis such as xylene and dearomatized hydrocarbon have synergistic effects at ratios 1:1 and 1:10 (w/w; natamycin:solvent) (Table 14).

TABLE 13
Antifungal effect of natamycin in combination with Wis
paraffinic oil (Solvesso ™ 200) against Pythium ultimum
infection tested on petri dishes. Measurements were performed
1 day after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 685.5 | 0.0 | | | |
| 25-0 | 691.8 | −0.9 | | | |
| 0-25 | 444.4 | 35.2 | | | |
| 0-12.5 | 466.7 | 31.9 | | | |
| 25-25 | 364.2 | 46.9 | 34.6 | 1.36 | Synergism |
| 25-12.5 | 432.2 | 37.0 | 31.3 | 1.18 | Synergism |

TABLE 14
Antifungal effect of natamycin in combination with Wis xylene
and dearomatized hydrocarbon (Exxsol ™ D220/240) against
Pythium ultimum infection tested on petri dishes. Measurements
were performed 2 days after placing the mycelium plug

| | | | | | |
|---|---|---|---|---|---|
| | Avg | | | | |
| Natamycin- | infected | | | | |
| solvent | area | | | | |
| (ppm) | (mm²) | Observed % | Expected % | O/E | Interaction |

| | | |
|---|---|---|
| 0-0 | 5444.6 | 0.00 |
| 25-0 | 5441.2 | 0.06 |

Exxsol ™ D220/240

| | | | | | |
|---|---|---|---|---|---|
| 0-250 | 5154.0 | 5.34 | | | |
| 25-250 | 5086.2 | 6.58 | 5.40 | 1.22 | Synergism |

Xylene

| | | | | | |
|---|---|---|---|---|---|
| 0-25 | 5371.2 | 1.35 | | | |
| 25-25 | 5245.7 | 3.65 | 1.41 | 2.59 | Synergism |

TABLE 15
Antifungal effect of natamycin in combination with Wis
aliphatic hydrocarbon (Isopar ™ V) against Pythium ultimum
infection tested on petri dishes. Measurements were performed
1 day after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 1265.9 | 0.00 | | | |
| 25-0 | 1174.0 | 7.26 | | | |
| 0-25 | 1263.9 | 0.16 | | | |
| 25-25 | 1155.8 | 8.70 | 7.40 | 1.17 | Synergism |

### Example 13: Effect of Wis Belonging to the Group of Esters on Natamycin Efficacy on Pythium ultimum Infection Tested on Petri Dishes

In this experiment, the Wis methyl caprylate product Steposol® C-25 (Stepan Company, Table 16), the Wis methyl soyate product Steposol® SB-W (Stepan Company, Table 17) and Agnique® ME 18 SD-F (BASF, Table 18) were tested as described in Example 1, using the indicated solvent levels.

### Results

It is concluded that a combination of natamycin and the Wis methyl caprylate have a synergistic effect against the oomycete Pythium ultimum at ratio 1:10 (w/w; natamycin:solvent) (Table 16). It is concluded that combinations of natamycin and the Wis methyl soyate have a synergistic effects against the oomycete Pythium ultimum at ratios 1:1 to 1:0.5 (w/w; natamycin:solvent) (Table 17). It is concluded that combinations of natamycin and the Wis methyl soyate (Agnique® ME 18 SD-F) have a synergistic effect against the oomycete Pythium ultimum at ratios 1:10 to 1:0.5 (w/w; natamycin:solvent) (Table 18).

TABLE 16
Antifungal effect of natamycin in combination with Wis
methyl caprylate (Steposol ® C-25) against Pythium ultimum
infection tested on petri dishes. Measurements were performed
1 day after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 1360.8 | 0.00 | | | |
| 25-0 | 1160.7 | 14.70 | | | |
| 0-250 | 361.8 | 73.41 | | | |
| 25-250 | 16.3 | 98.80 | 77.32 | 1.28 | Synergism |

TABLE 17
Antifungal effect of natamycin in combination with Wis
methyl soyate (Steposol ® SB-W) against Pythium ultimum
infection tested on petri dishes. Measurements were performed
1 day after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 685.5 | 0.0 | | | |
| 25-0 | 691.8 | −0.9 | | | |
| 0-25 | 508.5 | 25.8 | | | |
| 0-12.5 | 647.4 | 5.6 | | | |
| 25-25 | 383.1 | 44.1 | 25.2 | 1.75 | Synergism |
| 25-12.5 | 576.6 | 15.9 | 4.7 | 3.39 | Synergism |

TABLE 18
Antifungal effect of natamycin in combination with Wis
methyl soyate (Agnique ® ME 18 SD-F) against
Pythium ultimum infection tested on petri dishes. Measurements
were performed 2 days after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 3138.4 | 0.00 | | | |
| 25-0 | 3202.3 | −2.04 | | | |
| 0-250 | 3005.0 | 4.25 | | | |
| 0-25 | 3023.5 | 3.66 | | | |
| 0-12.5 | 2564.0 | 18.30 | | | |
| 25-250 | 2073.7 | 33.93 | 2.30 | 14.7 | Synergism |
| 25-25 | 2534.2 | 19.25 | 1.70 | 11.3 | Synergism |
| 25-12.5 | 2447.4 | 22.02 | 16.64 | 1.3 | Synergism |

### Example 14: Effect of Wis Belonging to the Group of Amides on Natamycin Efficacy on Pythium ultimum Infection Tested on Petri Dishes

In this experiment, the Wis N,N-dimethyldecenamide product Hallcomid® 1025 (Stepan Company, Table 19), the Wis N,N-dimethyldecanamide product Rhodiasolv® ADMA 10 (Solvay, Table 20), and the Wis mixture of N,N-dimethyloctanamide and N,N-dimethyldecanamide in the product Hallcomid® M-8-10 (Stepan Company, Table 21) were tested as described in Example 1. The respective solvent levels are presented in Tables 19-21.

### Results

It is concluded that combinations of natamycin and the Wis N,N-dimethyldecenamide, the Wis N,N-dimethyldecanamide (Table 20), and the Wis mixture of N,N-dimethyloctanamide and N,N-dimethyldecanamide have a synergistic effect against the oomycete Pythium ultimum at ratios 1:10 to 1:0.5 (w/w; natamycin:solvent) (Tables 19, 20 and 21, respectively).

TABLE 19
Antifungal effect of natamycin in combination with Wis N,N-
dimethyldecenamide (Hallcomid ® 1025) against Pythium ultimum
infection tested on petri dishes. Measurements were performed
2 days after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 5305.1 | 0.00 | | | |
| 25-0 | 4945.0 | 6.79 | | | |
| 0-250 | 0 | 100.00 | | | |
| 0-25 | 2118.6 | 60.06 | | | |
| 0-12.5 | 3666.2 | 30.89 | | | |
| 25-250 | 0 | 100.00 | 100.00 | 1.00 | Synergism |
| 25-25 | 858.45 | 83.82 | 62.77 | 1.34 | Synergism |
| 25-12.5 | 1788.6 | 66.29 | 35.58 | 1.86 | Synergism |

TABLE 20
Antifungal effect of natamycin in combination with Wis N,N-
dimethyldecanamide (Rhodiasolv ® ADMA 10) against
Pythium ultimum infection tested on petri dishes. Measurements
were performed 1 day after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 1360.8 | 0.00 | | | |
| 25-0 | 1160.7 | 14.70 | | | |
| 0-250 | 0 | 100.00 | | | |
| 0-12.5 | 494.2 | 63.68 | | | |
| 25-250 | 0 | 100.00 | 100.00 | 1.00 | Synergism |
| 25-12.5 | 267.9 | 77.54 | 69.02 | 1.12 | Synergism |

TABLE 21
Antifungal effect of natamycin in combination with Wis
mixture of N,N-dimethyloctanamide and N,N-dimethyldecanamide
(Hallcomid ® M-8-10) against Pythium ultimum
infection tested on petri dishes. Measurements were
performed 2 days after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 3138.48 | 0.00 | | | |
| 25-0 | 3202.3 | −2.04 | | | |
| 0-250 | 0 | 100.00 | | | |
| 0-25 | 828.5 | 73.60 | | | |
| 0-12.5 | 1404.5 | 55.25 | | | |
| 25-250 | 0 | 100.00 | 100.00 | 1.0 | Synergism |
| 25-25 | 673.2 | 78.55 | 73.06 | 1.1 | Synergism |
| 25-12.5 | 1306.0 | 58.39 | 54.34 | 1.1 | Synergism |

### Example 15: Effect of Wis Belonging to the Group of Ethers on Natamycin Efficacy on Pythium ultimum Infection Tested on Petri Dishes

In this experiment, the Wis cyclic ether 1,4-dioxane was tested as described in Example 1. The solvent levels are presented in Table 22.

### Results

It is concluded that combinations of natamycin and the Wis cyclic ethers have synergistic effects against the oomycete Pythium ultimum at ratios 1:10 to 1:1 (w/w; natamycin:solvent) (Table 22).

TABLE 22
Antifungal effect of natamycin in combination with Wis
cyclic ethers 1,4-dioxane against Pythium ultimum infection
tested on petri dishes. Measurements were performed
2 days after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 3138.4 | 0.00 | | | |
| 25-0 | 3202.3 | −2.04 | | | |
| 0-250 | 2753.9 | 12.25 | | | |
| 0-25 | 2725.43 | 13.16 | | | |
| 25-250 | 1500.9 | 52.18 | 10.47 | 5.0 | Synergism |
| 25-25 | 2694.1 | 14.16 | 11.39 | 1.2 | Synergism |

### Example 16: Effect of Water-Miscible Solvents on Natamycin Efficacy on Pythium Ultimum Infection Tested on Petri Dishes

In this experiments, the water miscible solvent isopropanol (Table 23), the water miscible dimethyllactamide solvent product Agnique® AMD 3L (BASF, Table 24), the water miscible dimethylformamide solvent (DMF, Table 24), the water miscible dimethyllactamide solvent (DMAc, Table 25), and the water miscible solvent N-butyl pyrrolidone (NBP, Table 26) were tested as described in example 1. The respective solvent levels are presented in Tables 23-26.

### Results

It is concluded that all combinations of natamycin and water-miscible solvents tested have no synergistic effects against the oomycete Pythium ultimum at ratios 1:10 to 1:0.5 (w/w; natamycin:solvent) (Tables 23-26).

TABLE 23
Antifungal effect of natamycin in combination with water-
miscible solvent isopropanol against Pythium ultimum
infection tested on petri dishes. Measurements were
performed at 2 days after placing the mycelium plug.

| | Avg | | | | |
|---|---|---|---|---|---|
| Natamycin- | infected | | | | |
| solvent | area | Ob- | Ex- | | |
| (ppm) | (mm²) | served % | pected % | O/E | Interaction |
| 0-0 | 5305.1 | 0.00 | | | |
| 25-0 | 4945.0 | 6.79 | | | |
| 0-250 | 3646.5 | 31.26 | | | |
| 0-12.5 | 4852.0 | 8.54 | | | |
| 25-250 | 4756.7 | 10.34 | 35.93 | 0.29 | No synergism |
| 25-12.5 | 4910.1 | 7.44 | 14.75 | 0.50 | No synergism |

TABLE 24
Antifungal effect of natamycin in combination with water-
miscible solvents dimethyllactamide (Agnique ®
AMD 3L) and dimethylformamide (DMF) against Pythium ultimum
infection tested on petri dishes. Measurements were performed
at 1 day after placing the mycelium plug.

| | Avg | | | | |
|---|---|---|---|---|---|
| Natamycin- | infected | | | | |
| solvent | area | Ob- | Ex- | | |
| (ppm) | (mm²) | served % | pected % | O/E | Interaction |
| 0-0 | 1360.8 | 0.00 | | | |
| 25-0 | 1160.7 | 14.70 | | | |

Agnique ® AMD 3L

| | | | | | |
|---|---|---|---|---|---|
| 0-250 | 1278.7 | 6.04 | | | |
| 0-25 | 1116.3 | 17.97 | | | |
| 0-12.5 | 1220.5 | 10.31 | | | |
| 25-250 | 1186.6 | 12.80 | 19.85 | 0.64 | No synergism |
| 25-25 | 1323.7 | 2.73 | 30.03 | 0.09 | No synergism |
| 25-12.5 | 1337.5 | 1.71 | 23.50 | 0.07 | No synergism |

DMF

| | | | | | |
|---|---|---|---|---|---|
| 0-250 | 1254.9 | 7.78 | | | |
| 0-25 | 1306.7 | 3.98 | | | |
| 0-12.5 | 1314.5 | 3.40 | | | |
| 25-250 | 1343.1 | 1.30 | 21.34 | 0.06 | No synergism |
| 25-25 | 1401.9 | −3.02 | 18.09 | 0.17 | No synergism |
| 25-12.5 | 1148.6 | 15.59 | 17.60 | 0.89 | No synergism |

TABLE 25
Antifungal effect of natamycin in combination with water-
miscible dimethyllactamide (DMAC) against Pythium ultimum
infection tested on petri dishes. Measurements were performed
at 1 day after placing the mycelium plug.

| | Avg | | | | |
|---|---|---|---|---|---|
| Natamycin- | infected | | | | |
| solvent | area | Ob- | Ex- | | |
| (ppm) | (mm²) | served % | pected % | O/E | Interaction |
| 0-0 | 1342.0 | 0.00 | | | |
| 25-0 | 1174.0 | 12.52 | | | |
| 0-250 | 1316.1 | 1.93 | | | |
| 0-12.5 | 1251.6 | 6.73 | | | |
| 25-250 | 1162.8 | 13.35 | 14.20 | 0.94 | No synergism |
| 25-12.5 | 1191.8 | 11.19 | 18.41 | 0.61 | No synergism |

TABLE 26
Antifungal effect of natamycin in combination with water-
miscible solvent N-butyl pyrrolidone (NBP) against Pythium ultimum
infection tested on petri dishes. Measurements were performed
at 2 days after placing the mycelium plug.

| | Avg | | | | |
|---|---|---|---|---|---|
| Natamycin- | infected | | | | |
| solvent | area | Ob- | Ex- | | |
| (ppm) | (mm²) | served % | pected % | O/E | Interaction |
| 0-0 | 3138.4 | 0.00 | | | |
| 25-0 | 3202.3 | −2.04 | | | |

NBP

| | | | | | |
|---|---|---|---|---|---|
| 0-250 | 1859.5 | 40.75 | | | |
| 0-25 | 1764.9 | 43.76 | | | |
| 0-12.5 | 3052.4 | 2.74 | | | |
| 25-250 | 2112.2 | 32.70 | 39.54 | 0.8 | No synergism |
| 25-25 | 1997.1 | 36.37 | 42.62 | 0.9 | No synergism |
| 25-12.5 | 3202.8 | −2.05 | 0.76 | −2.7 | No synergism |

### Example 17: Effects of Wis 2-ethylhexyl L-Lactate (EHL) on Natamycin and Thymol Efficacy on Pythium ultimum Infection Tested on Petri Dishes

In this experiment, the product Purasolv EHL® (Corbion) containing the Wis 2-ethylhexyl L-lactate (EHL), and thymol dissolved in water-miscible solvent EtOH at a concentration of 330 g/L, were tested as described in Example 1. The amount of each compound and the period after which the assessments were made are presented as specified in Table 27.

### Results

It is concluded that a combination of natamycin and the Wis EHL has a synergistic effect against P. ultimum at ratio 1:0.7 (w/w; natamycin:solvent). When combining natamycin to thymol dissolved in the water-miscible solvent EtOH, no synergistic effect was observed at a ratio of 1:0.7:0.25 (w/w; natamycin:EtOH:thymol). Surprisingly when adding to this non-synergistic combination of natamycin-thymol the Wis EHL, a synergistic effect was observed at ratio 1:0.7:0.25 (w/w; natamycin:solvent:thymol). The synergistic effect observed in the natamycin, thymol, EHL combination was higher than observed for the combination of natamycin and EHL alone (Table 27). Since in the sample containing natamycin, thymol in ethanol and additional EHL, the overall amount of solvents is higher than in a sample containing only natamycin and thymol dissolved in ethanol, an additional control was performed containing a combination of natamycin, thymol in ethanol, and additional ethanol (see Table 27). This later didn't not result in any synergistic effect. Overall, these results show that, in the presence of a Wis, the fungicidal activity of a second active ingredient, such as the terpenoid thymol, when combined with natamycin, is synergistically enhanced.

### Example 18: Effects of Wis n-Butyl L-Lactate on Natamycin and Thymol Efficacy on Pythium ultimum Infection Tested on Petri Dishes

In this experiment, thymol dissolved in the water-immiscible solvent n-Butyl L-lactate (Purasolv BLR, (Corbion) and thymol dissolved in water-miscible solvent EtOH at a concentration of 330 g/L, were tested as described in Example 1. The amount of each compound and results are presented as specified in Table 28 below.

### Results

It is concluded that combinations of natamycin, Wis BL and thymol have a synergistic effect against P. ultimum at a ratio of 1:0.7:0.25 (w/w; natamycin:solvent:thymol). A combination of natamycin, the water-miscible solvent EtOH and thymol at the same ratio, did not result in a synergistic effect (Table 28). These results show that, in the presence of a Wis, the fungicidal activity of a second active ingredient, such as the terpenoid thymol, when combined with natamycin, is synergistically enhanced.

### Example 19: Effect of Wis Belonging to the Group of Triglycerides on Natamycin Efficacy on Pythium ultimum Infection Tested on Petri Dishes

In this experiment, the Wis vegetable oil sunflower was tested as described in Example 1. The solvent levels are presented in Table 29.

### Results

It is concluded that combinations of natamycin and the Wis vegetable oil have a synergistic effects against the oomycete Pythium ultimum at ratios 1:0.5 (w/w; natamycin:solvent) (Table 29).

TABLE 27
Antifungal effect of natamycin and thymol in combination with water-immiscible
solvent EHL against P. ultimum infection tested on petri dishes. Measurements
were performed 1 day after placing the mycelium plug.

| Natamycin | EHL | Thymol | EtOH | Avg infected | Observed | Expected | | |
|---|---|---|---|---|---|---|---|---|
| (ppm) | (ppm) | (ppm) | (ppm) | area (mm²) | % | 0% | O/E | Interaction |
| 0 | 0 | 0 | 0 | 611.2 | 0.00 | | | |
| 25 | 0 | 0 | 0 | 624.8 | −2.22 | | | |
| 0 | 18.5 | 0 | 0 | 274.4 | 55.10 | | | |
| 25 | 18.5 | 0 | 0 | 211.5 | 65.39 | 54.10 | 1.2 | Synergism |
| 0 | 0 | 0 | 0 | 611.2 | 0.00 | | | |
| 25 | 0 | 0 | 0 | 624.8 | −2.22 | | | |
| 0 | 0 | 6.25 | 18.5 | 399.4 | 34.64 | | | |
| 25 | 0 | 6.25 | 18.5 | 463.3 | 24.19 | 33.19 | 0.7 | No synergism |
| 0 | 0 | 0 | 0 | 611.2 | 0.00 | | | |
| 25 | 0 | 6.25 | 18.5 | 463.3 | 24.19 | | | |
| 0 | 0 | 0 | 18.5 | 601.1 | 1.65 | | | |
| 0 | 18.5 | 0 | 0 | 247.7 | 55.10 | | | |
| 25 | 0 | 6.25 | 37 | 546.9 | 10.51 | 25.44 | 0.4 | No synergism |
| 25 | 18.5 | 6.25 | 18.5 | 103.6 | 83.05 | 65.96 | 1.3 | Synergism |

TABLE 28
Antifungal effect of natamycin and thymol in combination with water-immiscible
solvent BL and EtOH against P. ultimum infection tested on petri dishes.
Measurements were performed 1 day after placing the mycelium plug.

| Natamycin | BL | Thymol | EtOH | Avg infected | Observed | Expected | | |
|---|---|---|---|---|---|---|---|---|
| (ppm) | (ppm) | (ppm) | (ppm) | area (mm²) | % | % | O/E | Interaction |
| 0 | 0 | 0 | 0 | 629.9 | 0.00 | | | |
| 25 | 0 | 0 | 0 | 637.5 | −1.21 | | | |
| | | 6.25 | 18.5 | 399.5 | 36.59 | | | |
| | 18.5 | 6.25 | 0 | 427.5791 | 32.12 | | | |
| 25 | 0 | 6.25 | 18.5 | 454.8 | 27.80 | 35.82 | 0.78 | No synergism |
| 25 | 18.5 | 6.25 | 0 | 373 | 40.79 | 31.30 | 1.30 | Synergism |
| 0 | 0 | 0 | 0 | 629.9 | 0.00 | | | |
| 50 | 0 | 0 | 0 | 637.5 | −1.21 | | | |
| 0 | | 12.5 | 37.5 | 399.5 | 36.59 | | | |
| | 37.5 | 12.5 | 0 | 427.6 | 32.12 | | | |
| 50 | 0 | 12.5 | 37.5 | 454.8 | 27.80 | 35.82 | 0.78 | No synergism |
| 50 | 37.5 | 12.5 | 0 | 373 | 40.79 | 31.30 | 1.30 | Synergism |

TABLE 29
Antifungal effect of natamycin in combination with Wis
vegetable oil sunflower oil against Pythium ultimum
infection tested on petri dishes. Measurements were
performed 1 day after placing the mycelium plug.

| | Avg | | | | |
|---|---|---|---|---|---|
| Natamycin- | infected | | | | |
| solvent | area | | | | |
| (ppm) | (mm²) | Observed % | Expected % | O/E | Interaction |
| 0-0 | 615.3 | 0.00 | | | |
| 25-0 | 604.6 | 1.74 | | | |
| 0-12.5 | 610 | 0.86 | | | |
| 25-12.5 | 529.4 | 13.96 | 2.59 | 5.39 | Synergism |

1. A composition comprising natamycin and a water-immiscible solvent (Wis) in a ratio of between 1:20 and 20:1 (w/w; natamycin:Wis), and one or more surfactants.

2. The composition of claim 1, wherein said Wis is an ester, a ketone, an amide, a polyethylene- or polypropylene-oxide, an aliphatic and/or aromatic hydrocarbon, an ether, a triglyceride, or a mixture thereof.

3. The composition of claim 1, wherein the Wis comprises one or more linear or branched lactate esters.

4. The composition of claim 1, further comprising one or more of a terpene, a terpenoid, or a mixture thereof.

5. The composition of claim 4, wherein the ratio is between 1:5:5 and 5:1:0.2 (w/w; natamycin:Wis:terpene/terpenoid).

6. The composition of claim 1, which is an aqueous suspo-emulsion.

7. A method for protecting an agricultural plant or plant part, comprising providing a composition according to claim 1, and applying said composition to said agricultural plant or plant part.

8. The method of claim 7, wherein said plant part is a seed, bulb, fruit or vegetable.

9. The method of claim 7, wherein the method provides protection against ascomycetes, basidiomycetes and oomycetes.

10. A method for improving the development and/or yield of an agricultural plant, comprising providing a composition according to claim 1, and contacting the plant with said composition.

11. A method for protecting a soil and/or a growth substrate, the method comprising applying to said soil and/or a growth substrate a composition according to claim 1.

12. The method according to claim 11, wherein the growth substrate is a mushroom growth substrate.

13. The method according to claim 7, whereby said composition is undiluted or diluted in an aqueous solution or in oil, prior to applying the composition to a plant or plant.

14. The method according to claim 9, wherein the plant or plant part is a food product, and the food protected against fungi and fungus-like organisms.

15. The method of claim 14, wherein said fungus-like organisms include oomycetes.

16. The composition according to claim 1, wherein the natamycin:Wis ratio is between 1:5 and 5:1 (w/w),

17. The method of claim 2, wherein said Wis is an ester and said ester is a lactate ester.

18. The method of claim 11, whereby said composition is undiluted or diluted in an aqueous solution or in oil, prior to applying the composition to a soil and/or growth substrate.

19. The method according to claim 11, wherein the soil and/or growth substrate is protected against fungi and fungus-like organisms.

20. The method according to claim 19, wherein said fungus-like organisms include oomycetes.
